(19) United States
(12) Patent Application Publication
(10) Pub. No.: US 2018/0060417 A1
(43) Pub. Date: Mar. 1, 2018

(54) DIALECTICAL INFORMATION ARCHITECTURE

(71) Applicant: DIALECTICA, LLC, OLYMPIA, WA (US)

(72) Inventors: RICO PICONE, OLYMPIA, WA (US); BRYAN POWELL, BELLINGHAM, WA (US); JOTHAM LENTZ, LACEY, WA (US)

(21) Appl. No.: 15/672,259

(22) Filed: Aug. 8, 2017

Related U.S. Application Data
(60) Provisional application No. 62/372,232, filed on Aug. 8, 2016.

(51) Int. Cl. G06F 17/30

(52) U.S. Cl. CPC G06F 17/30601; G06F 17/3002; G06F 17/30327

(57) ABSTRACT

A dialectical information architecture is disclosed comprising an organic hierarchy information structure within which a plurality of information and data are arrayed according to categories and wherein subcategory relationships among the categories are generated by determining information or data associated among two or more categories. A computer system configured with such an architecture provides a user interface allowing a user to select any category and view information or data independently of that the selected category's relationship with any other category.

### CROSS-REFERENCE TO RELATED APPLICATIONS

The present application claims priority to U.S. provisional application No. 62/372,232, filed Aug. 8, 2016.

### BACKGROUND

### Field

The present disclosure relates generally to the field of information architecture, and particularly to a dialectical information architecture.

Description of the Problem and Related Art

Since the conception of personal computing, it has been the goal of various researchers and designers to create a computing system that can be a medium for human thought. Certainly, the art has progressed a long way toward realizing this; but it remains encumbered by conventional information architectures, i.e., the manners in which pieces of information are interrelated. Typical in these architectures, the basic unit of an information architecture is the “atom.” An atom, as it is used throughout this description, may be a word processing document, spreadsheet document, or other similar file, but need not be as large as a document. An atom may also be of lesser granularity, such as a paragraph, or a sentence. In some cases, an atom may be a database record, web page, or email message. Further, an atom may be text-based or comprise audio, video, imagery or other types of data which may be classified, tagged, searched or otherwise manipulated.

Atoms are logically related via “categories” (e.g. directory, tag, etc.). Categories can be considered as sets of atoms. It should be noted that this definition of a category is not the same as that of category theory. As used herein, a category is to be understood in the classical sense of a quality or attribute. It will be appreciated by those skilled in the relevant arts categories may be assigned by users or automatically assigned via automatic tagging protocols known in the art. The three conventional information architectures used today are “hierarchical,” “organic” and “sequential.”

Hierarchical Architecture.

As illustrated in FIG. 1A, a hierarchical architecture is an architecture in which atoms 103 and categories 101 are organized with parent-child relationships in a “tree” structure. The categories are arranged to encompass one-another, as in the case of a computer file system. For example, category 1.1 101a at Level 2 is a subcategory, or child, of category 1 101 at Level 1, category 1.1.1 101c at Level 3, is a child of category 1.1. 101a, and so on. Then atoms 103 populate the structure at various levels.

The advantages of this architecture include that it gives an intuitive structure to the information, with its spatial analogies like “up” and “in”, that it can be easily instantiated in a computing device, and that, in many instantiations, it can be navigated with minimal atoms and categories displayed at each level.

The hierarchical architecture has limitations, however. It cannot allow certain categorizations of atoms. For instance, if an atom can be associated with categories that lie in different “branches” of the tree, this cannot be properly expressed. Another limitation is that there is only a single path to each atom, for example, a file path in a standard computing system. With only a single path to it, a browser of the architecture must know all the “right” moves in order to arrive at the atom.

Organic Architecture. The organic architecture, depicted in FIG. 1B, is one which allows atoms 103 to be categorized with any combination of categories 101, but does not directly relate the categories 101 to each other. This architecture is instantiated in “tagging” systems, for instance, in which a tag can be considered a category 101. For example, Atom A6 is associated with Categories 2, 3 and Category N. It is “organic” in the sense that it evolves with each new atom's introduction to the structure. Unlike a traditional static hierarchy that requires insertion into the structure at a specific node, an organic hierarchy evolves with the information, and a user need not explicitly define the hierarchy, which is implicit in the user's categorization of each atom.

The lack of explicitly defined relations among the categories gives this architecture its characteristic “flat” structure. It is a significant improvement over the hierarchical architecture in connectivity, allowing all possible relationships to be expressed, but the structure among the categories is opaque, and, in fact, undefined. This is problematic when the architecture is instantiated into a computing system that is to be navigated (i.e. browsed). Where does one begin to navigate? What should be displayed at a given state of navigation?

Sequential Architecture. With reference to FIG. 1C, the sequential architecture is one which arranges atoms 103 or categories 103 in sequences with the relation “is followed by,” indicated in the figure by arrows. This architecture is exemplified in narrative, film, and music, and generally mimics the architecture of the human experience of events in time. For this reason, it is ubiquitous, although it is very limited, structurally.

It is common to create a synthesis of the sequential and hierarchical architectures, as in a document, with sections. Nominally, each subsection is related only to its (parent) section, although this is rarely actual. This synthesis is obviously fruitful, but inherits the limitations of the hierarchical architecture. Nonetheless, this provides an example of a successful synthesis of two prior art information architectures.

What follows is a series of three cumulative syntheses that sublates the standard architectures in an attempt to capture the structure of human thinking. The primary objective of this work is to enable a computer—instantiated with the information architecture set forth below—to be used as a better medium for human thinking.

### SUMMARY

For purposes of summary, certain aspects, advantages, and novel features are described herein. It is to be understood that not necessarily all such advantages may be achieved in accordance with any one particular embodiment. Thus, the systems and methods claimed may be embodied or carried out in a manner that achieves or optimizes one advantage or group of advantages as taught herein without necessarily achieving other advantages as may be taught or suggested herein.

The dialectical information architecture disclosed below comprises an organic hierarchy information structure within which information arrayed according to categories and wherein subcategory relationships among the categories are generated by determining information or data associated among two or more categories. A computer system configured with such an architecture provides a user interface allowing a user to select any category and view that category's information independently of the selected category's relationship with any other category.

Further, the organic hierarchy explicitly permits information and data to be associated with one or more categories and those associations to be presented to a user via the user interface. The presentation of information to a user in this manner allows the user to synthesize disparate items of information thus allowing the information to evolve as the user traverses the presentation of the information via the user interface.

The organic hierarchy provides a structure within which items of information are stored and allows the information to be selectively viewed in a manner similar to that of the human brain, traversing from one thought to a seemingly unrelated thought. The structure and traversal mechanisms allow for dialectical synthesis of multiple pieces of information.

In an alternative embodiment, the organic hierarchy allows the storage and presentation of quantitative information, such as data, by assigning to a piece of information a category membership value indicative of the degree to which the information belongs in a given category. In this embodiment, the user interface is configured to render a display that represents the degree to which that information is associated with a selected category.

### BRIEF DESCRIPTION OF THE DRAWINGS

A dialectical information architecture is described herein with reference to the accompanying drawings. In the drawings, like reference numbers indicate identical or functionally similar elements. Additionally, the left-most digits of a reference number identifies the drawing in which the reference number first appears.

FIG. 1A illustrates a prior art hierarchical information structure;

FIG. 1B depicts a prior art organic information structure;

FIG. 1C models a prior art sequential information structure;

FIG. 2A illustrates an example of distribution of atoms and categories for use in explaining generation of a dialectical information architecture;

FIG. 2B is a Venn diagram of the scenario illustrated in FIG. 2A for use as a reference example in explaining the generation of a dialectical information architecture;

FIG. 3 is a flow chart of an exemplary process for synthesizing a hierarchical structure and an organic structure;

FIG. 4 is a graph of an exemplary synthesized organic hierarchy information structure given the example scenario shown in FIG. 2 according to the process described with reference to FIG. 3;

FIG. 5 is a flow chart of an exemplary process for defining metacategories;

FIG. 6 is a flow chart of an exemplary process for defining visible and hidden subcategory relations;

FIG. 7 is a graph of an exemplary organic hierarchy information structure; and

FIG. 8 is a functional schematic of an exemplary computer-based device for executing a process for generating a dialectical information architecture;

FIG. 9 is a flowchart depicting a process for user navigation within an organic hierarchy data structure;

FIG. 10 is a functional schematic of an exemplary software architecture of a system for generating an organic hierarchy data structure;

FIGS. 11A-11C are plots of simulated temperature (K), pressure (kPa), and air density (kg/m³) data, respectively, as a function of altitude;

FIGS. 12A-12D are plots of the respective fuzzy membership functions of the simulated data presented in FIGS. 11A-11C;

FIG. 13A is a screen capture of an exemplary user interface display in which a notional user has selected a node of the intersection of quantitative data categories which comprise high temperature and mid-pressure data atoms;

FIG. 13B shows a following screen after which the user has subsequently navigated to a new node comprising data category, rho_hi, intersected with the previous node;

FIG. 13C presents a screen capture wherein the user has now chosen to deselect the p_md data category; and

FIG. 14 is a functional schematic diagram of an exemplary network system for implementing a fuzzy dialectical architecture.

### DETAILED DESCRIPTION

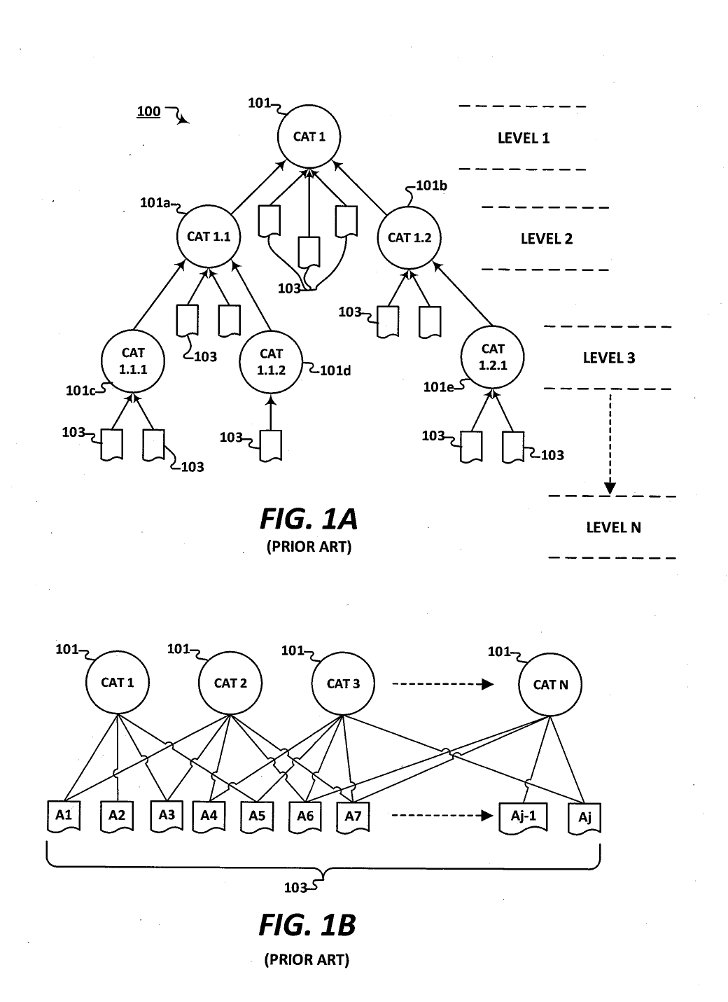

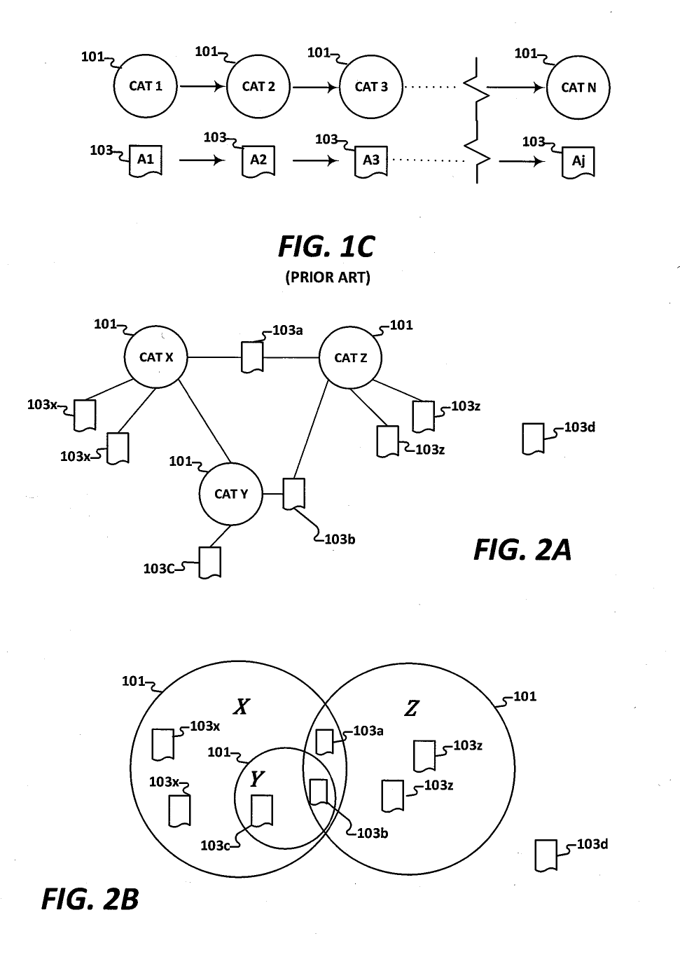

The various embodiments of the dialectical information architecture and their advantages are best understood by referring to FIGS. 1 through 14 of the drawings. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

The subject matter of this disclosure may be embodied in computer-based devices, systems, methods, or computer program products. Accordingly, some or all of the subject matter may be embodied in hardware or in program logic (including firmware, resident program logic, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

The following detailed description introduces a new information architecture that is a synthesis of an information structure, information flow (e.g. narrative), and information dialectic (its logical evolution). Insights from the memory mnemonic, the “method of loci,” and the philosophical process of dialectic are introduced. This new architecture is a cumulative synthesis of organic, hierarchical, and sequential architectures, with a dialectical method. Accordingly, an exemplary dialectical information architecture may be thought of as a cumulative synthesis of the structure, flow and dialectic planes.

An exemplary dialectical information architecture may be constructed in three dimensions, or “planes”: the structure plane, the flow plane, and the dialectic plane. The structure plane is the set of logical relations among the categories and atoms and is often the primary focus of conventional information architectures, but it can take different forms. The hierarchical architecture has structure in its category-to-category and atom-to-category relations, whereas the organic architecture has structure only in its atom-to-category relations.

The flow plane is the sequential presentation of atoms or categories. As in the method of loci, human thinking flows from one idea to the next, not in any necessary order prescribed by a structure, but a structure provides context for each idea. This is what distinguishes “flow” from the concept of “path.” A path is the logical categorization of an idea, whereas flow is a sequential presentation of ideas.

The quintessential example of the concept of flow is a narrative, which is often presented in terms of chapters, sections, and subsections. This exemplifies a synthesis of the sequential and hierarchical architectures. However, as stated above, it inherits the limitations of the hierarchical architecture in that a flow cannot move freely through the structure due to its restrictions on logical categorizations.

The dialectic plane is the evolution of structures and flows within the architecture. This plane is often ignored in information architecture and its instantiations. Attempts to incorporate it include backup program logic, wiki revision histories, and program logic version control. Framing it with the dialectical method allows the user to focus on the evolution of the ideas and not a specific flow. It also allows the user to discover new antitheses that arise in connection with other work in the information system.

Dialectic provides a framework for the evolution of thinking. It begins with a thesis, which gives a perspective on a topic. If a new perspective is introduced, it is called an antithesis. The antitheses can be contradictory to the thesis, but often they are not. Rather, they reveal something previously unknown about the topic, and the relationship between the thesis and antithesis is unresolved. The process of sublation, which in this context refers to the preservation and change of a term or concept through dialectical interaction with another term or concept, forms a synthesis, which includes both the thesis and antithesis. This synthesis is considered a new thesis.

### First Synthesis: Organic Hierarchy Structure

Construction of a dialectical architecture preferably begins with a synthesis of a hierarchical structure and an organic structure into what may be referred to as an organic hierarchy. In such a structure, the first requirement is that any set of categories may be associated with any given atom. However, an organic structure does not define category-category relationships, but this is an aspect of a hierarchical structure that provides advantages over its organic counterpart. Therefore, a second requirement of the organic hierarchy is that category-category relationships are implicit in, but must be computed from, the organic categorization of atoms.

By way of example, FIG. 2A presents a plurality of atoms 103 which may or may not be associated with one or more of a plurality of categories, X, Y, and Z 101. In this scenario, atoms 103x are associated exclusively with Category X, and atoms 103z are associated exclusively with Category Z. Category Y is in a “child” relationship with Category X and includes atom 103c and atom 103b. Atom 103a is associated with both Category X and Category Z, and Atom 103b is associated with both Category Y and Category Z. Atom 103d is not associated with any category 101. Thus, FIG. 2A illustrates a hybrid of a hierarchical category relationship (e.g., the relationship between Y and X) and an organic relationship between atoms and categories (e.g., the association of atom 103a with both X and Z).

FIG. 2B is a Venn diagram depicting the scenario shown in FIG. 2A. It can be seen that by virtue of the hierarchical relationship of X to Y, Y is a subset of X, and thus the atoms associated with Y (atoms 103b, c) are indirectly associated with X. Further, since atom 103a is associated with both X and Z, it occupies the intersection of X and Z, and similarly atom 103b is within the intersection of Y and Z.

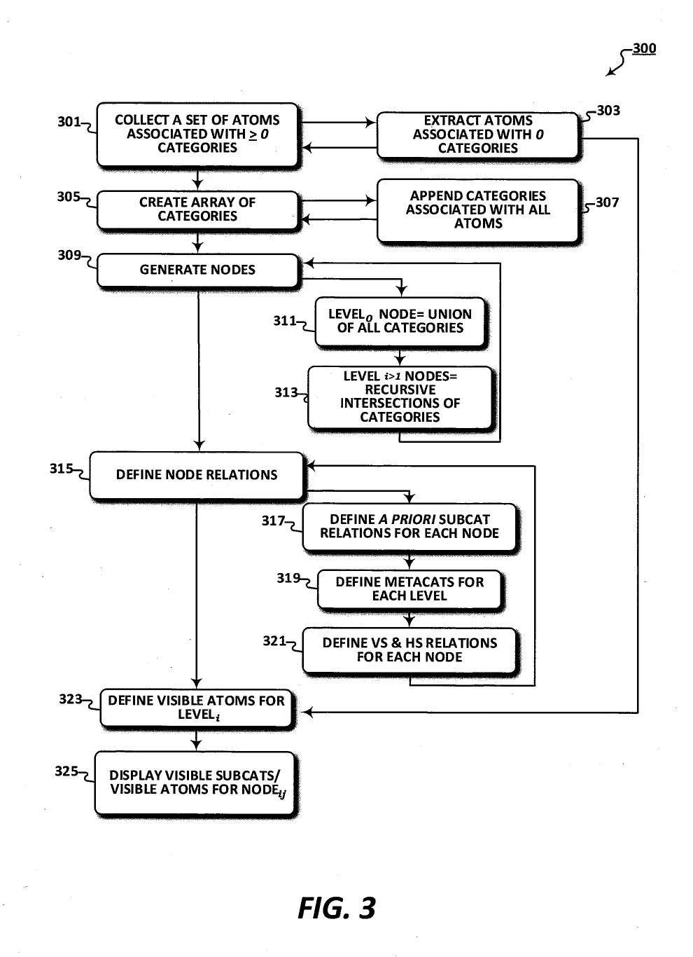

A process 300 for synthesizing hierarchical and organic structure is presented in the flowchart of FIG. 3. At step 301 a collection of atoms is obtained and all categories with which the atoms are associated are extracted and arrayed at step 305. Atoms not associated with any category are extracted and stored 303 for display, as will be described below. For the example, atoms 103 are collected and their associated categories 101, X, Y and Z are arrayed. The unassociated atom 103d is extracted and stored.

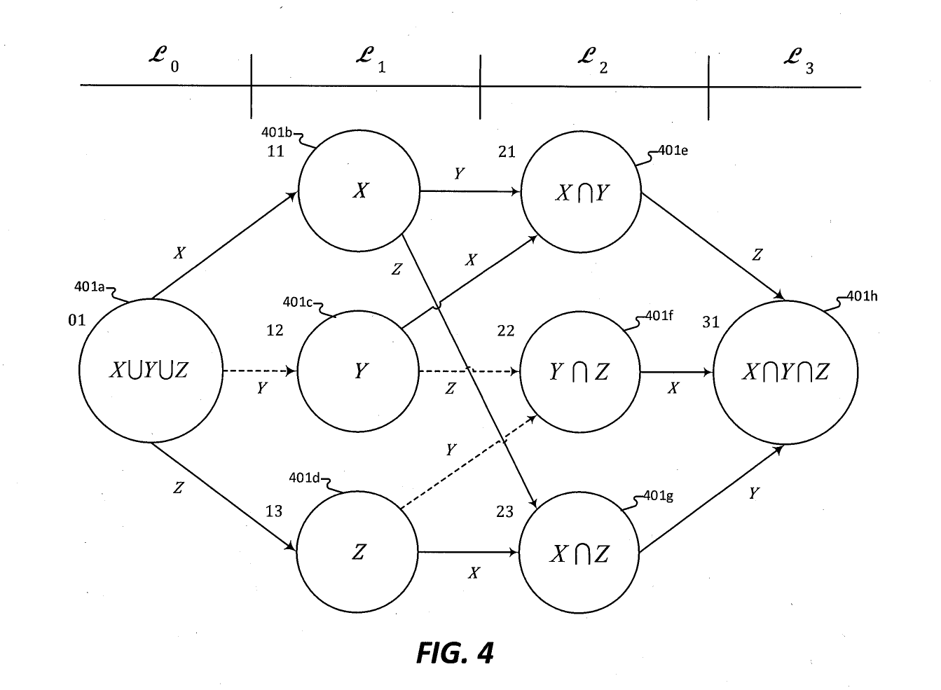

Next, a set of category nodes is generated at step 309 which will be understood with reference to FIG. 4, a graphical presentation of nodes 401 generated according to the process described herein. Given the categories X, Y and Z, the set [symbol] of nodes 401 is given by

[symbol]

= [symbol] ∪ [symbol] ∪ [symbol] ,
where
[symbol] is the union of categories, X∪Y∪Z
[symbol] is the set of categories, X, Y and Z, and
[symbol] is the set of non-empty recursive intersections of the elements of C, or, in the example, [symbol] ={X, Y, Z, X∩Y, Y∩Z, X∩Z, X∩Y∩Z}. Nodes are identified by level, i and index number, j. So, node 401a may be referred to as Node 01, etc.

At steps 311 and 313 nodes 401a-h are distributed among levels whereby level [symbol] ₀ is occupied the node 401a consisting of the union of categories, X∪Y∪Z, and level [symbol] ₁ is designated where each node is one of the categories, nodes 401b-d. The next level, [symbol] ₂, is where each node is the second iteration of intersections of the categories, or nodes 401e-g. The last level in this example is occupied by the node 401h consisting of the intersection of all categories, X∩Y∩Z. Those skilled in the relevant arts will appreciate the number of levels after [symbol] ₀ will correspond to the number of categories in [symbol] . The generation of node levels may be expressed as a function, L: [symbol] → [symbol] where L is equal to 0 if the node is nε [symbol] , equal to 1 if the node nε [symbol] , and equal to the number of categories Cε [symbol] for which the node n was the intersection, otherwise. [symbol] ᵢ is defined as the collection of sets for which L(n)=i for nε [symbol] , and may be indexed such that a relationship between nodes, r, may be denoted rᵢ^{jk} meaning the relationship between node j of [symbol] ᵢ to node k of [symbol] ᵢ₊₁.

Next, at step 315, inter-level node relationships are defined, beginning with identifying all a priori subcategory relations 317 which are subcategory relationships required by construction of the sets. Thus, assuming it is not an empty set, node 21 401e X∩Y is in an a priori subcategory relation with node 11 401b X.

It is from the plurality of inter-level node relationships that metacategories for each level, [symbol] ᵢ, may be understood and defined at step 319. A set of metacategories, [symbol] , is a set of the recursive unions of nodes of level [symbol] ᵢ. Thus, in the present example, for the nodes in level [symbol] ᵢ, the set of metacategories is {X, Y, Z, X∪Y, X∪Z, Y∪Z, X∪Y∪Z}. Further, the metacategories may be identified by a depth, d, corresponding to the degree of the recursion. The maximum depth will be equal to the number of a priori subcategory relations. So, in the present case d_{MAX}=3. For example, at the first recursion, d=1, the metacategories will be the union of each node with itself. It will be appreciated, therefore, that each category is itself a metacategory. At the second recursion, d=2, the set of metacategories will be the union of each node with each other node, or, the union of each metacategory with each other metacategory at that depth.

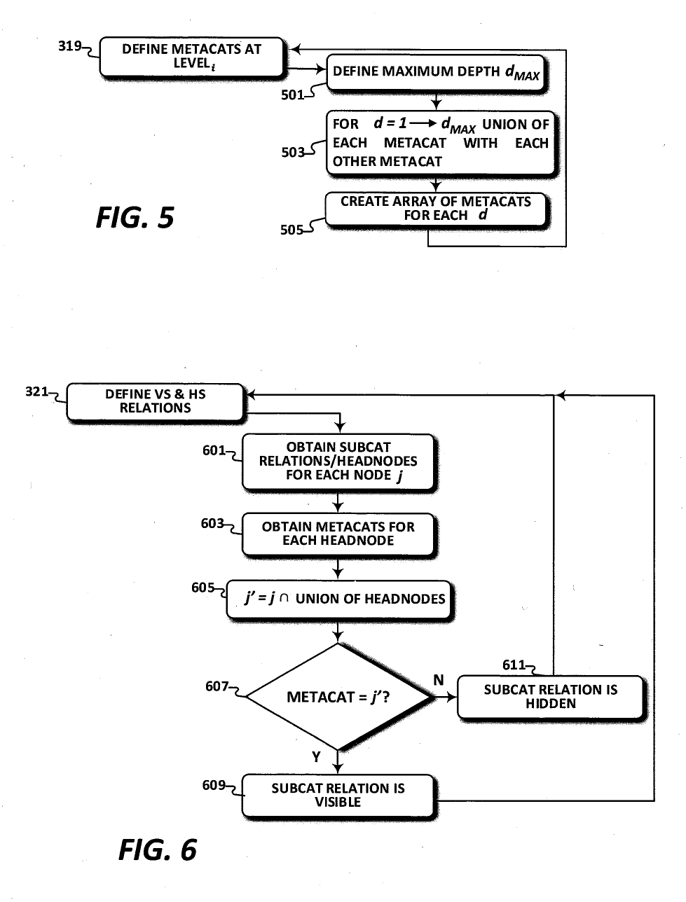

FIG. 5 is a flowchart of an exemplary process for the step of defining metacategories 319. For a level, [symbol] ᵢ, a maximum depth, d_{MAX} is defined to be the number of subcategory relations, step 501. Then, for each depth d=1→d_{MAX}, define a new metacategory as a union of each metacategory with each other metacategory, step 503. Finally, create an array of the metacategories for each node identified by level and depth, step 505.

So, for [symbol] ₁ the sets of metacategories by depth, [symbol] ^{d}, are

[symbol]

¹={X,Y,Z},

[symbol]

²={X∪Y,X∪Z,Y∪Z}, and

[symbol]

³={X∪Y∪Z}.

Metacategories are used to define visible subcategory (“VS”) relations, step 321. Let j be a node in level [symbol] ᵢ that is a common tail-node for a set of head-nodes in level [symbol] ᵢ₊₁ having a priori subcategory relationships with j. Further, let [symbol] ᵢⱼ be the set of metacategories for the set of such head-nodes. A head-node kin [symbol] ᵢ₊₁ is in VS relation with tail-node j where it is an a priori subcategory of j, is an element of the set of nodes used to construct [symbol] ᵢⱼ that have the minimum depth dₘᵢₙ and that equal j′ defined as the tail-node j intersected with the union of the set of head-nodes. Accordingly, VS relations for a given node 401 are evaluated by examining the subcategory relations with the node 401 has the tail-node. The head-nodes are constructed into a set of metacategories as described above. Any relation that is not a VS relation is a hidden subcategory (“HS”) relation.

FIG. 6 is a flowchart of an exemplary process for defining VS and HS relations 321. At step 601 the subcategory relations and their respective head-nodes are obtained for each node j. Step 603 obtains the metacategories for each head-node obtained in the previous step. j′ is constructed in step 605 as the intersection of node j with the union of the set of head-nodes. Then, at 607, j′ is compared to the metacategories. If a metacategory is equal to j′, it is designated as “visible,” i.e., a VS relation 609. Otherwise, it is designated a hidden or HS relation 611.

Referring back to the example, Table 1 lists the metacategories for each node 401.

TABLE 1

| Node ij | [symbol] ᵢⱼ¹ | [symbol] ᵢⱼ² | [symbol] ᵢⱼ³ |
|---|---|---|---|
| 01 | {X, Y, Z} | {X ∪ Y, Y ∪ Z, X ∪ Z} | {X ∪ Y ∪ Z} |
| 11 | {X ∩ Y, X ∩ Z} | {X ∩ (Y ∪ Z)} | |
| 12 | {X ∩ Y, Y ∩ Z} | {Y ∩ (X ∪ Z)} | |
| 13 | {X ∩ Z, Y ∩ Z} | {Z ∩ (X ∪ Y)} | |
| 21, 22, 23 | {X ∩ Y ∩ Z} | | |

Node 01 401a is the tail-node j for three head-nodes: Nodes 11, 12 and 13. The construction j′ for Node 01 is (X∪Y∪Z)∩(X∪Y∪Z)=X∪Y∪Z. It can be seen that no metacategory at depth d=1 equals j. At depth d=2, only X∪Z=j′. Therefore, the subcategory relations from Node 01 401a to Node 11 401b and Node 13 401d are VS relations.

Evaluating the relations for Node 11 401b, j′=X∩((x∩Y)∪(X∩Z)). It can be seen that no single metacategory at depth d=1 equals j′. At depth d=2, however, metacategory [symbol] ₁₁² is equal to j′. Consequently, both of the subcategory relations from tail-node 11 401b are VS relations. In this manner, all subcategory relations are defined as either VS or hidden relations. In the graph of FIG. 4, VS relations are indicated by solid arrows while hidden relations are indicated by, dashed arrows.

Referring again to FIG. 3, at step 323 visible atoms are defined for each level, [symbol] ᵢ. A visible atom is an atom 103 is one that for node jε [symbol] ᵢ is in the set j that are not in the set j′. For level [symbol] ₀, all atoms not associated with categories are visible. In the example, that is atom 103d (FIGS. 2A & 2B). For level [symbol] ₁, the visible atoms are X″Y∪Z, or atoms 103x (FIGS. 2A & 2B).

The set of nodes 401 together with the set of VS relations and HS relations define a graph of categories depicted in FIG. 4. The graph can be navigated by beginning at any node and following an edge to an adjacent level ( [symbol] ᵢ to [symbol] ᵢ₊₁ or to [symbol] ᵢ₋₁). When the level increases, the line of forward progression, or “edge,” represents the intersection of the current node with a single category, and can therefore be thought of as “selecting” an additional category. When the level decreases, the edge represents the union of the current node with a single category, and can therefore be thought of as “deselecting” that category. At a given node, visible atoms and categories in VS relation with that node are displayed (FIG. 3: step 325). HS relations are not displayed but are accessible.

Second Synthesis: Organic Hierarchy with Flow

The method of loci is an ancient memory mnemonic still in use by most memory champions. The technique requires a subject to “place” memories in an imaginary world familiar to the subject. It turns out that the technique is not then used as random-access memory in which the user can access any memory at will; rather, each memory-location is accessed in series by “journeying” through the imaginary world.

This architecture is already expressed in the standard sequential information architecture. This architecture is fundamentally different than the other information architectures mentioned, which express the logical relations among sequences and atoms (i.e. they are structural). The sequential architecture has no structure itself; rather, it expresses the movement of thinking through information structure. It moves in another dimension, which we call the flow plane of information architecture. The flow plane of an information architecture is the sequential presentation of atoms or categories.

As in the method of loci, thinking flows from one idea to the next, not necessarily in some order prescribed by the structure, but through the structure, which provides context for each idea. This is what separates the concept of information flow from that of information path. It will be appreciated that path is the logical categorization of information (e.g., the pathname for a document file), whereas flow is a sequential presentation of information.

The quintessential example of a flow is a narrative, which is often presented in terms of chapters, sections, and subsections. This is a synthesis of the sequential and hierarchical architectures. Its utility is undeniable; it is the structure of nearly all scientific and technical literature. However, it inherits the limitations of the hierarchical architecture in that a flow cannot move freely through the hierarchical structure due to its restrictions on logical categorizations.

With this in mind, the second synthesis is the sublation of the organic hierarchy and a sequential architecture, described above, or a synthesis of flow and structure. This synthesis is rooted in two rules. First, that information flow should not be limited by information structure. For example, a chapter in a book compares the works of Soren Kierkegaard and Friedrich Nietzsche. In a hierarchical architecture, the dilemma is whether this belongs in Kierkegaard/Nietzsche or Nietzsche/Kierkegaard. It imposes a structure on the flow that does not exist.

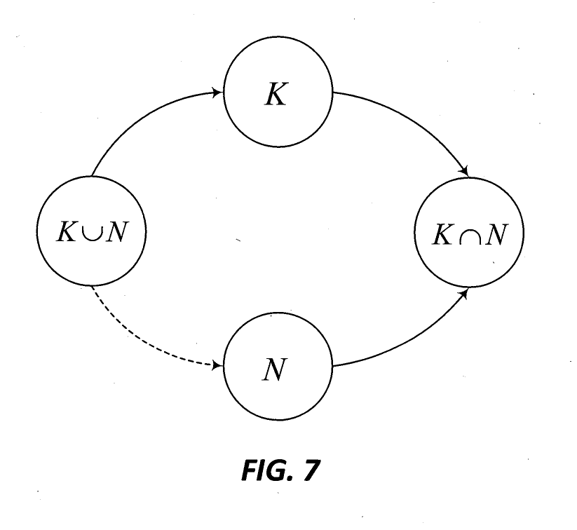

In an organic hierarchy, however, an information flow has no such limitations. The cornerstone of the organic hierarchy is that each atom—the Kierkegaard-Nietzsche chapter, in this case—may be associated with any category. Therefore, in any instantiation of this architecture, it will be available to a user under both Kierkegaard/Nietzsche and Nietzsche/Kierkegaard. And yet, the structure among the categories is not lost, as in a purely organic architecture. It still may be the case that in a given information system every atom associated with Nietzsche is also associated with Kierkegaard, but some atoms associated with Kierkegaard are not associated with Nietzsche. Therefore, Nietzsche c Kierkegaard, and Nietzsche would be hidden within Kierkegaard in graph navigation, as illustrated in FIG. 7, where the dashed line represents a hidden (HS) subcategory relation.

This would look identical to a user browsing a hierarchical structure with Nietzsche a subcategory of Kierkegaard, but it does not restrict future categorizations, unlike the hierarchy. Moreover, unlike in a hierarchy, there is nothing prohibiting a user from navigating to Nietzsche immediately (by manual input). It is an allowed, but not a visible (displayed to the user), navigation.

The second rule is that the flow structure, or the categorizations that create a flow, should be highly varied and detailed. Designating a flow, say, a book chapter, a document or a video file, as a single atom is typically not sufficiently granular to capture the movement of the flow through the structure. Each of those examples may be categories for more minute atoms. A book chapter may contain an atom that is a paragraph on Byzantine mosaics. A document about quantum physics may comprise a section on Richard Feynman, which may further include mention of the Massachusetts Institute of Technology, and so on.

Another advantage of the organic hierarchy structure is there is no single path to arrive at an information node, unlike a hierarchical structure. From the example shown in FIGS. 2A & 2B, the path from category Xto category Yin a hierarchical system would only be X→Y. In the organic hierarchy, however, many paths are possible because the order is irrelevant. X→Y is equivalent to Y→X because each path represents the intersection X∩Y=Y∩X. This flexibility of path is especially important for information discovery. It allows a user to navigate “up” along a different path than they navigated “down.”

Third Synthesis: Organic Hierarchy and Flow with Dialectic

The Fichtean/Hegelian dialectic provides a framework for the evolution of thinking. It begins with a thesis, which gives a perspective on a topic. If a new perspective is introduced, it is called an antithesis. Antitheses can be contradictory to the thesis, but often they are not. Rather, they reveal something previously unknown about the topic, and the relationship between the thesis and antithesis is unresolved. The process of sublation forms a synthesis, which includes both the thesis and antithesis. This synthesis is considered a new thesis.

In this final synthesis, the dialectical framework can be used to express the evolution of thought. Each category may be assigned a thesis flow that is a definition or description of the category. It will certainly intersect a number of other categories, but it is specifically used to define its thesis category. Similarly, any flow can be considered the thesis flow for a thesis category it generates.

When a flow is newly associated with a category, it becomes an antithesis flow of the category's thesis flow. It may contradict, supplement, or be redundant with the thesis flow. In any case, when a user sublates these flows, they become a synthesis flow, which is the new thesis flow for the category.

This third synthesis is called the dialectical architecture. It allows information to be structured as in the organic hierarchy (first synthesis), incorporates free-ranging flows (second synthesis), and systematically structures the evolution of thinking (third synthesis). In other words, the overall architecture provides a mechanism for flows to evolve within the framework of thesis to antithesis to synthesis. This captures a third plane of information architecture.

The dialectical information architecture described above may be generated by program logic executed on one or more computers and may be locally or remotely accessible. The computers may be uniprocessor or multiprocessor machines. Additionally, these computers include an addressable storage medium or computer accessible medium, such as random access memory (RAM), erasable programmable read-only memory (EPROM), read-only memory (ROM), hard disks, floppy disks, laser disk players, optical disk players, digital video devices, and other components operable to transmit and/or store data. The verification tool is advantageously configured reside on the addressable storage medium and configured to execute on one or more processors.

The detailed description that follows is presented largely in terms of processes and symbolic representations of operations performed by conventional computers, including computer components. A computer may be any microprocessor or processor (hereinafter referred to as processor) controlled device, such as, by way of example, personal computers, workstations, servers, clients, mini-computers, main-frame computers, laptop computers, a network of one or more computers, mobile computers, portable computers, handheld computers, palm top computers, set top boxes for a TV, interactive televisions, interactive kiosks, personal digital assistants, interactive wireless devices, mobile browsers, or any combination thereof. The computer may possess input devices such as, by way of example, a keyboard, a keypad, a mouse, a microphone, or a touch screen, and output devices such as a computer screen, printer, or a speaker.

The computer may be a uniprocessor or multiprocessor machine. Additionally, the computer includes memory such as a memory storage device or an addressable storage medium. The memory storage device and addressable storage medium may be in forms such as, by way of example, a random access memory (RAM), a static random access memory (SRAM), a dynamic random access memory (DRAM), an electronically erasable programmable read-only memory (EEPROM), a programmable read-only memory (PROM), an erasable programmable read-only memory (EPROM), hard disks, floppy disks, laser disk players, digital video disks, compact disks, video tapes, audio tapes, magnetic recording tracks, electronic networks, and other devices or technologies to transmit or store electronic content such as programs and data.

The computer executes an appropriate operating system such as Linux, Unix, Microsoft® Windows® 95, Microsoft® Windows® 98, Microsoft® Windows® NT, Apple® MacOS®, IBM® OS/2®, and the like. The computer may advantageously be equipped with a network communication device such as a network interface card, a modem, or other network connection device suitable for connecting to one or more networks.

The computer, and the computer memory, may advantageously contain program logic or other substrate configuration representing data and instructions, which cause the computer to operate in a specific and predefined manner as, described herein. The program logic may advantageously be implemented as one or more modules. The modules may advantageously be configured to reside on the computer memory and execute on the one or more processors. The modules include, but are not limited to, program logic or hardware components that perform certain tasks. Thus, a module may include, by way of example, components, such as, program logic components, processes, functions, subroutines, procedures, attributes, class components, task components, object-oriented program logic components, segments of program code, drivers, firmware, micro-code, circuitry, data, and the like.

The program logic conventionally includes the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art to effectively convey teachings and discoveries to others skilled in the art.

The program logic is generally considered to be a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computer.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language.

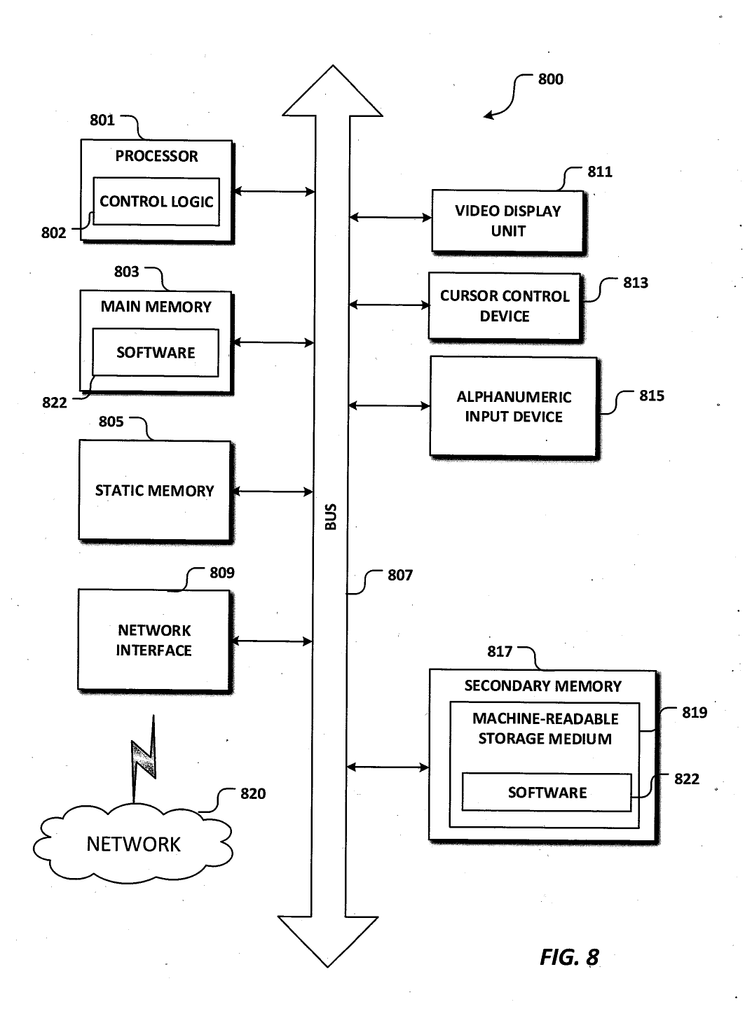

FIG. 8 illustrates a diagrammatic representation of a machine in the exemplary form of a computer system 800 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 800 includes a processor 801, a main memory 803 (e.g., read-only memory (ROM), flash memory, dynamic random access memory (DRAM) such as synchronous DRAM (SDRAM) or Rambus DRAM (RDRAM), etc., a static memory 805 (e.g., flash memory, static random access memory (SRAM), etc.), and a secondary memory 817 (e.g., a data storage device), which communicate with each other via a bus 807.

Processor 801 represents one or more general-purpose processing devices such as a microprocessor, central processing unit, or the like. More particularly, the processor 801 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 801 may also be one or more special-purpose processing devices such as an application specific integrated circuit (ASIC), a field programmable gate array (FPGA), a digital signal processor (DSP), network processor, or the like. Processor 801 is configured to execute the program logic 802 for performing the operations and steps discussed herein.

The computer system 800 may further include a network interface device 808. The computer system 800 also may include a video display unit 811 (e.g., a liquid crystal display (LCD) or a cathode ray tube (CRT)), an alphanumeric input device 813 (e.g., a keyboard), and a cursor control device 813 (e.g., a mouse).

The secondary memory 817 may include a machine-readable storage medium (or more specifically a computer-readable storage medium) 819 on which is stored one or more sets of instructions (e.g., program logic 822) embodying any one or more of the methodologies or functions described herein. The program logic 822 may also reside, completely or at least partially, within the main memory 803 and/or within the processing device 801 during execution thereof by the computer system 800, the main memory 803 and the processing device 801 also constituting machine-readable storage media. The program logic 822 may further be transmitted or received over a network 820 via the network interface device 809.

The machine-readable storage medium 819 may also be used to store an organic hierarchy structure and its associated data as described above, and/or a program logic library containing methods that call modules that execute generation of the organic hierarchy structure. While the machine-readable storage medium 819 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

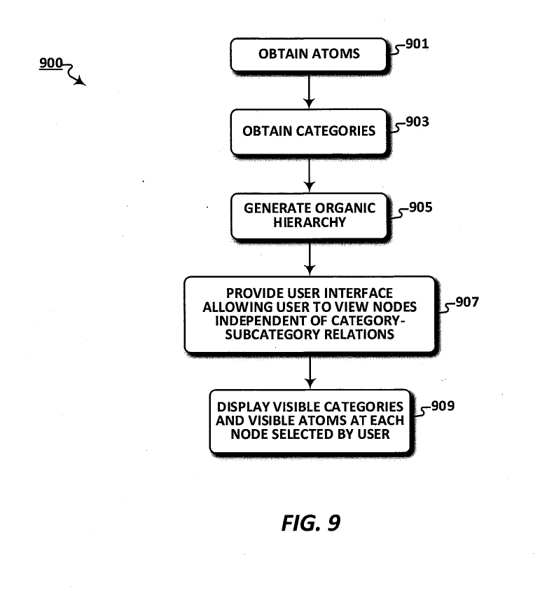

FIG. 9 presents a flow chart of an exemplary process 900 for providing information to a user using a dialectical architecture described above. At Step 901, atoms 103 are obtained from a variety of sources. Atoms 103 are processed to determine categories 101 with which the atoms are associated 903. The process next generates an organic hierarchy 905 which is populated with the atoms 103 and categories 101 obtained in steps 901 and 903 respectively. The generated organic hierarchy is then provided to a user as a user interface 907 that permits a user to select and view category nodes 401 of the organic hierarchy structure independent of category-subcategory relations of the information and, at Step 909, for each node 401 selected by a user, display only visible categories and visible atoms.

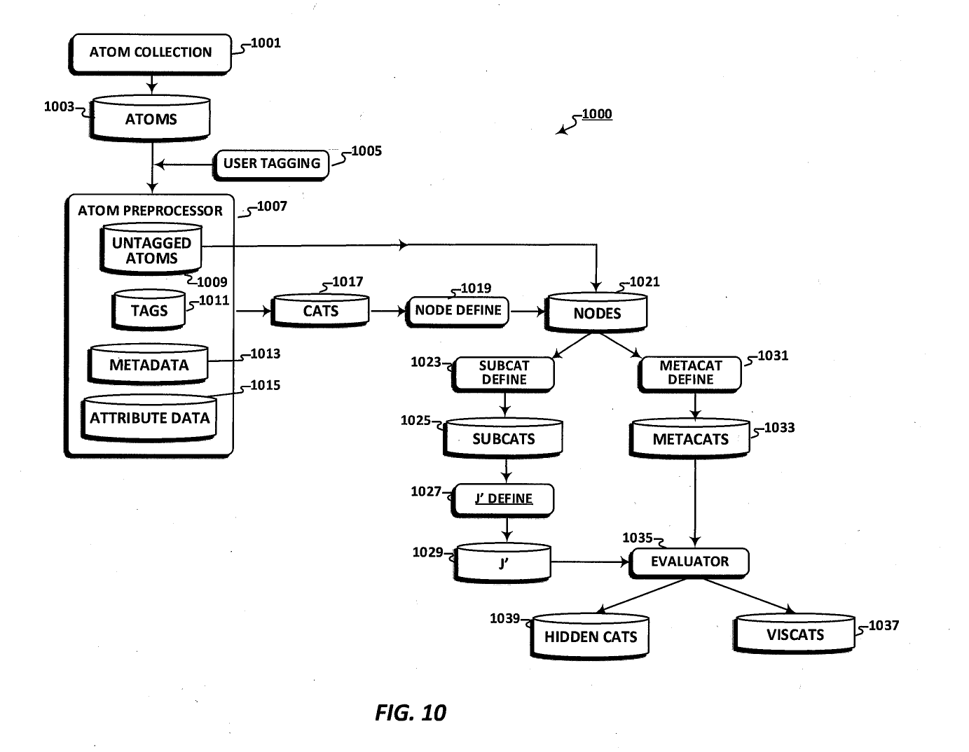

Referring now to FIG. 10, a functional diagram 1000 for a software system for generating an organic hierarchy architecture is presented illustrating possible submodules and their interoperation. A module 1001 for obtaining atoms 103 provides collected atoms to an atom database 1003. A preprocessor module 1007 determines categories 101 with which the atoms 103 are associated, and preferably may also associate atoms to categories automatically and may accept category associations from user tagging 1005. The preprocessor 1007 applies category data to one or more databases of category tags 1009, metadata 1011, and attribute data 1013. Category data is used to populate a category database 1017. The preprocessor may also populate a database of uncategorized atoms 1009.

A module for defining the architecture nodes 1019 retrieves the category data and constructs the nodes 401 which are provided to a database of nodes 1021. Data from the node database 1021 are provided to modules to define subcategories 1023 and metacategories 1031 for each node and which provide such definitions to respective subcategory and metacategory databases 1025, 1033. A j′ node definition module retrieves the subcategory data from the subcategory database 1025 and constructs the j′ nodes as described above for determining visible and hidden categories. Each metacategory and j′ is provided to an evaluator 1035 that compares the metacategories and j′ at each level and populates respective databases of visible and hidden categories 1037, 1039.

Consistent with the above-described “crisp” architecture, a second embodiment is based on fuzzy set theory subset operations that define the graph theory nodes. A limitation of the crisp architecture above is that while it may easily categorize qualitative information through tagging, quantitative information, such as data, is not so easily represented in this fashion. In this second embodiment, fuzzy set theory is employed so that quantitative information can be interpreted qualitatively in the form of categories. Two types of graph edges are defined such that a user interface based on this architecture can logically minimize the number of visible navigable edges and atoms of information. This minimization is understood to be one of the primary advantages of the architecture for human-computer interaction due to its mitigation of information overload. The advantages of hierarchical, organic, and sequential information architectures are fused by the architecture and the dialectical method is also integrated, all of which are intended to enhance human-computer interaction. This architecture can easily incorporate quantitative information, which can be converted into a fuzzy set theory representation with fuzzy clustering and other techniques. Moreover, traditionally qualitative information such as narrative, audio, and video, although naturally represented with crisp sets, can be represented with fuzzy sets. Therefore, this second exemplary architecture can fuse traditionally disparate types of information.

Consider a collection of data, each member of which we call an atom. Each atom is associated to a certain degree with a collection of categories which are represented as fuzzy sets. Crisp set operations union ∪ and intersection ∩ are analogous to the fuzzy set operations union and intersection. We exploit this analog to define the fuzzy dialectical architecture in a way similar to the definition of the crisp dialectical architecture, which made much use of the crisp set operations.

The fuzzy structure is, as its crisp analog, a directed graph of nodes and edges. Other than the “universal” union node, which contains all atoms, every node in the graph represents the fuzzy intersection of a collection of categories (fuzzy sets). Just as an atom can belong to a given category with membership value in the interval [0, 1], with zero meaning “no” membership and unity meaning “full” membership, so an atom can belong to a given node to a certain degree (membership value). This degree is computed from the fuzzy intersection operation, which returns the minimum membership value for a given atom shared between two nodes; i.e. let the element x in the universe X have membership μ_{A} (x) in fuzzy set A, where μ_{A} is the membership function for the set A, let x have membership μ_{B} (x) in fuzzy set B with membership function μ_{B}, and let [symbol] be the operator that takes the minimum of its two arguments—then the membership of x in the fuzzy intersection A∩B is

μ_{A∩B}(x)=μ_{A}(x) [symbol] _{B}(x).

As in the previous embodiment, directed edges connect the nodes to generate a natural hierarchy. All edges are defined by has a priori subcategory relations or “s-relations.” For example, the node A∩B is an a priori subcategory (fuzzy subset) of fuzzy sets A and B. This generates a natural hierarchy with graph levels defined by the number of categories that intersect to define the node; e.g. node A∩B has level two. Further, subcategory relations are defined as either “visible” or “hidden.” Hidden a priori relations, or “hs-relations,” occur when a metacategory for a given node contains as a subset all atoms associated with that node. A node's visible relations are those that have tails connected to the node and heads connected to subcategory nodes contained in a minimal subcategory. “Minimal,” as used herein means the minimum number of subcategories to fully contain all atoms. Consequently, an hs-relation is a relationship that is not a visible s-relation.

Finally, atoms themselves can be either “visible” or “hidden,” names suggestive of how the user interface in later sections will be defined. An atom is visible at a given node if and only if it has nonzero membership in all categories intersected to define the node and zero membership in all others. This definition requires that an atom be visible in one and only one node in the structure. The advantage of this instantiation for the user is that she is not presented with myriad information to navigate through, only visible relations. Hidden relations may be seen when the user selects an edge whereby a hidden relationship or atom becomes visible.

As suggested above, a fuzzy architecture comprises a collection of fuzzily categorized atoms, including quantitative information, i.e. data points, with membership values in each category. For a given variable, say temperature, the subset relationships are pre-defined by the membership function of the data; e.g. “luke-warm” will be a subset of “warm.” However, the inter-variable relationships are typically not so; for instance, “cold” might be a subset of “high-pressure.” The structure defined here can be understood as an estimation process for these relationships

Another aspect of the crisp architecture that ports almost directly to the fuzzy architecture is that of the invariance of path—that is, the fact that navigation of the structure is invariant to the order in which one navigates. Let us represent each navigation along a vs-relation as the “selection” of the additional category for the intersection that defines the edge's head node. Let each selection add that category to the path, similar to a traditional file system path (e.g. /AB/C). For the dialectical architecture, the order of the selection is inconsequential; for instance, /A/B/C, /B/A/C, and/C/AB all point to the same node, due to the invariance of the fuzzy intersection operation.

The concept of a “flow” was introduced in the context of the crisp dialectical architecture. It's definition, a flow is a series of atoms, applies directly to the fuzzy dialectical architecture, but unique implications emerge. Previously, flows have been used to represent the sequential aspect of several types of information, such as narrative, audio, and video. In a fuzzy dialectical architecture representing quantitative information, each data point is an atom and a data stream is a flow. Thus, each atom should not be presented to a user as an isolated data point at each node, but should be displayed in a plot, described below, with a trace representative of a flow. This yields an additional method of navigation, as well. A flow may intersect a node and continue on another node; the user should be able to “follow the flow” to the other node in addition to navigating the categorical structure directly, via edges.

The “thesis” flow of the crisp architecture also applies to the fuzzy embodiment of the dialectical architecture. Again, a thesis flow for each node can be understood as a user's description of the intersection of the categories defining the node. When another flow intersects a thesis flow, it is considered an antithesis flow to the thesis. A user would then be prompted to resolve these to form a newly informed thesis, or “synthesis.” But flow intersections are in fact not limited to thesis flows, so each intersecting flow is an antithesis to a given flow. This dialectical manner can have many instantiations; for instance, consider a thesis flow for the node A∩B (the relationship between A and B). Perhaps a user has written a document comprising this thesis flow, and then brings in a new quantitative data set such that the flow it defines intersects A∩B. The thesis flow would then require the sublation of the thesis and the antithesis (data). In this way, when newly connected information is introduced to the information system, those flows that are affected can be immediately identified.

In constructing this architecture, it will be appreciated that processes to instantiate the fuzzy dialectical architecture might require significant computation time assuming current processing technologies. However, preferred embodiments should be practiced such that the entire structure need not be recomputed when a new atom is inserted or removed. This allows the structure to be incrementally built, which should, of course, be invariant to the order in which atoms are inserted. This is especially important for real-time applications such as robotics. Hence, only the relations connecting a new node associated with the newly inserted atom should be recalculated and most of the structure remains untouched by the insertion of a new atom. Furthermore, the visibility or hiddenness of an atom never needs to be computed because an atom is visible in only one node, that which is defined by the intersection of all categories associated with it.

It will also be appreciated that any node that is new to the structure requires no structural computation, since all its relations must be vs-relations because no relation can possibly contain more than the others, since only one atom (the new one) is at the “bottom” of those paths. This allows extremely quick insertions for new categories and combinations of categories. The unavoidably most computationally intensive aspect of the computation is the re-computation of metacategories for those nodes affected by the insertion of a new node. It is important to note that once a minimal metacategory has been found at a given level, no more levels are required. It is also of note that memory resources can become an issue if the structure is maintained in memory (especially if metacategories are stored). It is advisable to use a graph database to persist and access the structure.

As with the crisp architecture of the first-described embodiment, certain preferable guidelines for a user interface should be noted. It will be appreciated by those skilled in the relevant arts that these guidelines are not exhaustive, nor are they limiting. The invention may be implemented with using only some or even none of these preferred features.

First, the user should be able to browse nodes like a traditional hierarchy. The nodes represent the intersection of categories, as they typically do in a hierarchy or in tag-based browsing. The hierarchy has a long and illustrious history of value to human thinking. Although the structure is, in fact, a graph, it will be natural to most users to experience it as a hierarchy. The “hierarchy” the user interacts with will be organic in the sense that it may change when new information is added to the system. All the spatial metaphors so valuable to hierarchies will be applicable, like “up” and “down,” “in” and “out.” At each node, the visible edges should be represented as single categories, i.e., the category that would be intersected with the current node to yield the lower node.

Next, the user should be presented only visible edges. “Information overload” has been identified as a significant challenge to our information age. One of the primary advantages of the dialectical architecture is that it minimizes the amount of information a user is presented at each node, much like a traditional hierarchy, which “tucks” the information that is further-categorized into lower levels. This means “hidden” atoms and edges should not be presented, explicitly (although exceptions can be made, of course). In some instances, hidden atoms, as defined above, might also be hidden from the user's view; however, caution is advisable here, since in some instances, the interface might call for their visibility.

The user should also be able to browse “up” to any parent node. The property of the architecture that the path order is invariant can be exploited to allow browsing the structure in a manner analogous to the hierarchical “up-one-level,” but with multiple possibilities. The user can traverse “up” to any parent node, of which there may be several, unlike in the hierarchy, which allows each node to have only a single parent. This can be visualized by allowing the user to de-select any selected category along the path, and not merely the last-selected.

Similarly, the user should be able to browse by following edges or flows. Following edges is the structural method of navigating and is isomorphic to browsing traditional hierarchies. The dialectical architecture adds the ability to browse along flows as well. A flow can intersect a node for one or more consecutive atoms, then move to another node. For instance, an article may be discussing the intersection of several topics, then drill deeper into it with an additional categorization, which would lead it to a child node. This could be navigated by “going with the flow,” such that the user continues to see the series of atoms that comprise the flow.

Consistent with the concept of the dialectic, the user should be able to synthesize newly intersecting flows. The dialectical aspect of the architecture requires the thesis-antithesis-synthesis structure of information development. An information attempting to enhance human thinking should certainly capture the development of that thinking, which this feature accomplishes. A flow can be “intersected” when another flow is coincident with a node the flow traverses, and this intersection may provide a new perspective to the original flow (antithesis). A user should be able to synthesize the two perspectives such that their information system remains well-curated.

Quantitative data are preferably displayed to the user in graph form. With the inclusion of quantitative information, the fuzzy dialectical architecture should have a user interface that presents quantitative information in a concomitant manner, typically a graph. A data point (atom) that is visible at a given node may belong to a multivariate data set and belongs to the node with some membership value in the range [0, 1]. Thus, the sense of fuzzy logic. An atom can belong to a fuzzy set to a certain degree, quantified by the membership value. A two-dimensional graph of given data set intersecting a node is often the best option; the user's ability to change which variables are plotted on the abscissa and ordinate axes is important. Data series should be connected and multiple series on the same graph should appear with different line properties or colors.

Finally, the user should be presented the membership of an atom in a node. The fuzziness of the architecture yields an interesting aspect of the information: the degree to which each atom belongs to a given node. For quantitative information, the membership value of each point in the node should be presented, preferably, as an opaque data type. For other types of information, several techniques are possible, including sorting, iconic differentiation, color, and opacity.

The following presents an example implementation of the fuzzy dialectical architecture constructed by the inventors hereof and comprising quantitative data. For this example, data comprises atmospheric measurements from sensors deployed on a balloon. Each data point consists of four parameters: altitude, temperature, pressure and air density. The Committee on Extension to the Standard Atmosphere (COESA) has defined a mathematical model used here to synthesize sensor data. The data points were categorized using fuzzy set theory, parsed with an algorithm that computes the fuzzy dialectical structure, and presented to the user. This data set was chosen for demonstration purposes because changes in air properties with altitude are well-understood.

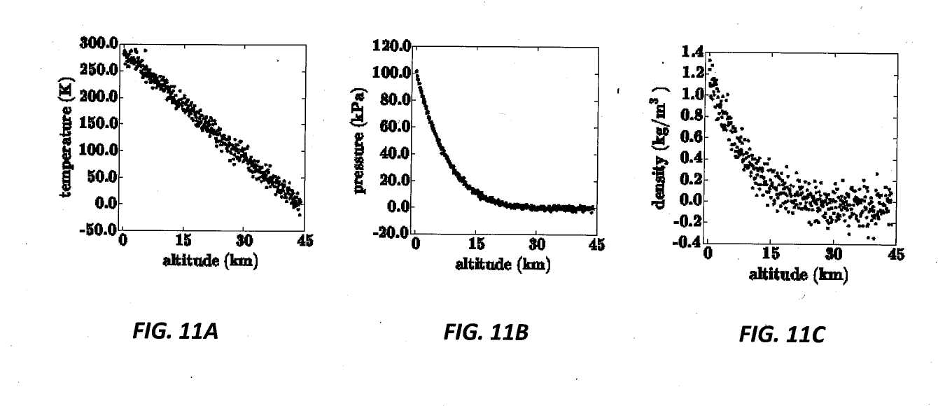

Simulated sensor data was generated in Python™, available from the Python Software Foundation, using “Scikit Aero.” An objective of this project is to analyze continuous streams of sensor data coming from scientific robots, so Python was chosen for compatibility with the robotics simulation environment MORSE. Scikit Aero has the COESA standard atmosphere model. In order to simulate sensor variability, the generated data was randomized with a standard distribution appropriate to the type of data, the results of which are displayed in FIGS. 11A, B & C. The figures are plots of simulated temperature (K), pressure (kPa), and air density (kg/m³), respectively as a function of altitude.

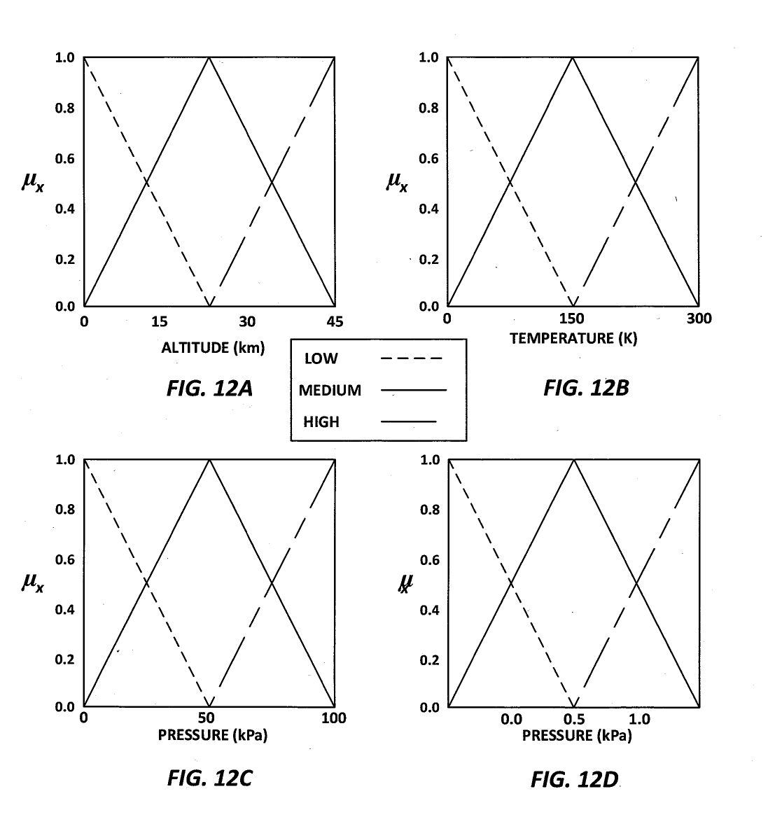

The fuzzy architecture presents data based on relationships between categories. Quantitative information such as sensor data require preprocessing in order to be actionable by the algorithm. The exemplary fuzzy membership functions are presented in FIG. 12. Fuzzy set theory was utilized to categorize the data. Three categories were defined for each variable (altitude, temperature, pressure, and density) by assigning membership functions. For simplicity, all modifier categories are titled “high,” “medium,” and “low” for each variable. Assigning the original data membership in each category resulted in each measurement having 16 separate values (four variables plus membership values in 12 categories). All category membership functions are triangularly shaped and evenly divided across the data. The Python package “Scikit Fuzzy” was employed to generate the membership functions and to assign a fuzzy membership value to each category for each data point. While these categories are adequate for this demonstration, the user should preferably be provided the flexibility to tune membership functions to more accurately align with user selected categories. A user would have the ability to quickly and intuitively define categories based on data type and origin. It can be seen in this example that three fuzzy categories for each variable are evenly distributed across the range of values for the respective variable.

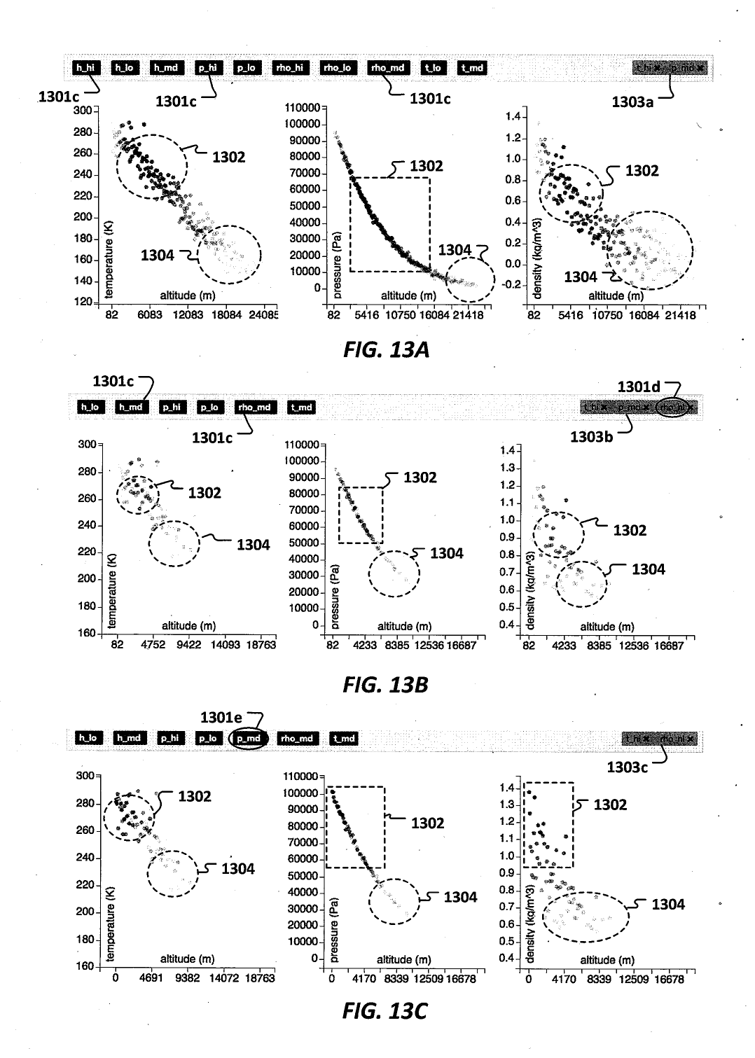

The exemplary interface, developed using the above guidelines, presents the quantitative atmospheric data illustrated in FIGS. 11A-11C according to certain nodes selected by a notional user. With reference now to FIG. 13A, assume a first exemplary node 1303a is defined by the intersection of two categories 1301a, b: high-temperature (t_hi) and mid-pressure (p_md), respectively. In this instantiation, all graphs present the altitude on the abscissa and the other variables on the ordinate. The selected node 1303a is displayed in the upper-right corner, in this example indicating the selection of the node comprising the intersection of two categories 1301a, b (t_hi intersect p_md). The user can deselect the node 1303a by clicking the “X.” Along the top of the display, the data categories 1301c having vs-relationships with the currently displayed node 1303a are presented. Accordingly, these categories 1301c represent edge traversals available from the current node 1303a. Hidden categories (hs-relations) are not displayed. The opacity of each data point is representative of the value of its membership function in the node, and so, atoms having a strong association 1302 with both categories 1301a, b based on the value derived from the category membership function, μ(x), should display a greater degree of opacity than those atoms with a lesser value of μ(x) 1304.

FIG. 13B shows the display when selecting vs-relation category comprising high density data (rho_hi) 1301d. The new node 1303b is now defined by t_hi∩p_md∩rho_hi. Note how the display has changed such that only the data most strongly associated with this new node 1303b is displayed. Finally, FIG. 13C shows the result of an “up” traversal performed by deselecting the p_md category 1303b.

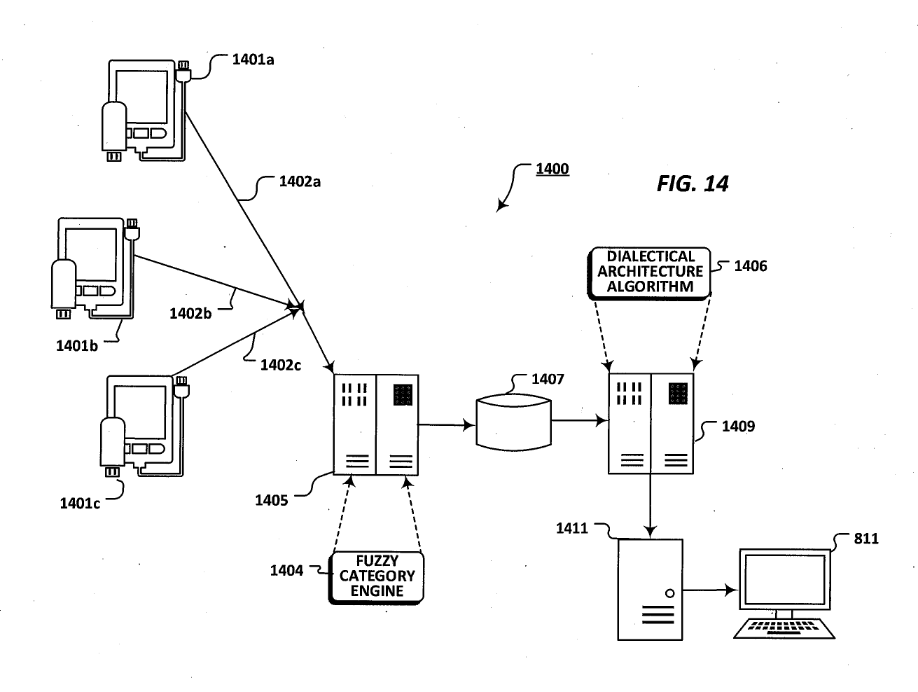

FIG. 14 illustrates an exemplary computer system for implementing the fuzzy dialectical architecture 1400. Collected sensor data 1402a-c from one or more sensors 1401a-c can be processed by a fuzzy categorization engine 1404 residing in the memory of a computer processing device which associates sensor data to the appropriate categories, and applies the category membership function to the data. The processed data is written to a database 1407, and then retrieved by a computer configured with a fuzzy dialectical algorithm 1406 resident in the memory of another computer processing device 1409 which reads the retrieved data and populates a dialectical architecture according to the process described above. A user at user interface display 811 requests the data via server 1411 and the data is displayed in a manner similar to that described.

Although, this present system and method may be implemented on one properly configured computer device, the use of the stand-alone database separates categorization from analysis and presentation. This modular hierarchy of collection, categorization, storage, and retrieval may be preferable because it enhances the resiliency and flexibility of the system. Each module can be run on a different physical system at a different geographical location depending on the requirements of the individual implementation. Once continuous streams of data are categorized and stored, they are no longer time-sensitive, and can be batch-processed by the fuzzy architecture algorithm.

The fuzzy dialectical algorithm used in this prototype was written in Ruby [23, v 2.4.0] and powers the user interface, which was built using the Pakyow [12, v 0.11] web application framework, which features graphs generated by c3.js [11, v 0.4.11]. Future implementations may be configured to graphically include flow visualization and traversal disparate data types (this instantiation shows only quantitative information, but this is incidental and not an inherent limitation).

As described above and shown in the associated drawings, the present disclosure is directed to a dialectical information architecture. While particular embodiments have been described, it will be understood, however, that any invention appertaining to the information architecture described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A computer system comprising:
an organic hierarchy data structure stored within a computer-readable storage medium configured with program logic for generating said organic hierarchy data structure, said data structure comprising:
a plurality of information atoms, each of said atoms being at least one of a text-based atom, an image-based atom, an audio-based atom, and a video-based atom; and
a plurality of information categories wherein a portion of said information atoms of said plurality of information atoms are associated with at least one information category, and wherein some of said information categories are subcategories;
wherein said each said information category may be accessed independently of relationships with other information categories within said plurality of information categories.

2. The computer system of claim 1, wherein said organic hierarchy data structure further comprises:
a plurality of levels, said plurality of levels comprising:
a first level, said first level comprising a single node representing a union of all information categories within said plurality of information categories;
a plurality of sublevels, each said sublevel comprising a plurality of nodes, each said node within a sublevel representing an information subcategory of a node in a preceding sublevel; and
a last level comprising a single last node, said last node representing the intersection of all information categories within said plurality of information categories.

3. The computer system of claim 2, wherein each information atom of said plurality of information atoms is associated with a membership value, said membership value representing a degree of association an information atom has with an information category.

4. The computer system of claim 1, further comprising a user interface configured to display said plurality of information categories and to allow a user to selectively view each said information category independently of relationships with other said information categories.

5. The computer system of claim 4, wherein said user interface is further configured to display only visible categories and visible atoms for each information category selected by said user.

6. The computer system of claim 5, wherein said organic hierarchy data structure further comprises:
a plurality of levels, said plurality of levels comprising:
a first level, said first level comprising a single node representing a union of all information categories within said plurality of information categories;
a plurality of sublevels, each said sublevel comprising a plurality of nodes, each said node within a sublevel representing an information subcategory of a node in a preceding sublevel; and
a last level comprising a single last node, said last node representing the intersection of all information categories within said plurality of information categories.

7. The computer system of claim 6, wherein each information atom of said plurality of information atoms comprises a membership value, said membership value representing a degree of association an information atom has with an information category.

8. The computer system of claim 7, wherein said user interface is further configured to render an indication of the degree of association an information atom has with a selected information category based upon said membership value of said information atom.

9. The computer system of claim 8, wherein said user interface is further configured to display only visible categories and visible atoms for each information category selected by said user.

10. A process for providing information to a computer user comprising the steps of:
obtaining a plurality of information atoms, each of said information atoms being one of text, video, imagery, audio, and data;
associating one or more of said plurality of information atoms with one or more information categories;
generating an organic hierarchy information architecture comprising said information categories and information subcategories derived from said information categories; and
providing a user interface configured to allow said user to view any of said information categories and said information subcategories independent of the relationships between an information category or subcategory.

11. The process of claim 10, further comprising:
displaying via said user interface only visible information categories and visible information atoms for each said information category or information subcategory viewed by said user.

12. The process of claim 11, wherein said step of generating said organic hierarchy comprises the steps of:
generating a plurality of nodes, said nodes representing one of said information categories and said information subcategories;
defining subcategory relationships for each said node within said plurality of nodes; and
defining visible and hidden subcategory relationships for each said node within said plurality of nodes.

13. The process of claim 12, further comprising the step of:
defining visible information atoms.

14. The process of claim 13, wherein the step of generating a plurality of nodes comprises the steps of:
defining a first node representing the union of all information categories;
defining nodes representing each information category within said plurality of information categories; and
recursively defining nodes representing the intersection of information categories within said plurality of information categories.

15. The process of claim 10, further comprising the step of:
assigning a membership value to each information atom, said membership value representing a degree to which an information atom is associated with an information category and an information subcategory.

16. The process of claim 15, further comprising the step of:
displaying an indication of the membership value of an information atom to said user.

17. The process of claim 16, wherein said step of generating said organic hierarchy comprises the steps of:
generating a plurality of nodes, said nodes representing one of said information categories and said information subcategories; and
defining subcategory relationships for each said node within said plurality of nodes.

18. The process of claim 17, wherein said step of generating said organic hierarchy further comprises the step of:
defining visible and hidden subcategory relationships for each said node within said plurality of nodes.

19. An information architecture comprising:
a structure plane, said structure plane comprising a set of logical relationships among information atoms;
a flow plane, said flow plane comprising a rendering of information categories and said information atoms such that a user may select any information category or atom independently of relationships with other information categories; and
a dialectic plane, said dialectic plane comprising a first user-selected information category, and at least one intersecting information category.

20. The information architecture of claim 19, wherein said information atoms are at least one of qualitative and quantitative information.
